(19) United States
(12) Patent Application Publication
(10) Pub. No.: US 2026/0356364 A1
(43) Pub. Date: Nov. 12, 2026

(54) VEHICLE CONTROL DEVICE, VEHICLE CONTROL METHOD, AND NON-TRANSITORY RECORDING MEDIUM

(71) Applicant: TOYOTA JIDOSHA KABUSHIKI KAISHA, Toyota-shi (JP)

(72) Inventor: Yoshiki NAKATSURU, Tokyo-to (JP)

(73) Assignee: TOYOTA JIDOSHA KABUSHIKI KAISHA, Toyota-shi (JP)

(21) Appl. No.: 19/645,393

(22) Filed: Apr. 13, 2026

(30) Foreign Application Priority Data
May 8, 2025 (JP) 2025-078061

(51) Int. Cl. B60W 30/18; B60W 50/14

(52) U.S. Cl. CPC B60W 30/181; B60W 50/14; B60W 2520/10; B60W 2552/20; B60W 2720/10

(57) ABSTRACT

A vehicle control device suppresses a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling, and performs a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

### FIELD

The present disclosure relates to a vehicle control device, a vehicle control method, and a non-transitory recording medium.

### BACKGROUND

PTL 1 (JP-A-2014-063455) discloses a technology to prevent a vehicle from traveling out of control by exceeding a speed limit at dangerous spots such as blind corners. In the technology described in PTL 1, a safe driving designated area including the blind corners is set in map information, and a control of the speed of the vehicle is performed to prevent the traveling speed from exceeding the speed limit when the vehicle is located within the safe driving designated area.

Even when the control to suppress the speed of the vehicle like the technology described in PTL 1 is performed, if the driver cannot recognize the reason why the control is being performed, the driver may perform an override, as a result, there is a risk that the vehicle may not be able to travel safely.

### SUMMARY

In view of the above-described points, it is an object of the present disclosure to provide a vehicle control device, a vehicle control method, and a non-transitory recording medium that can make a driver of a host vehicle recognize a reason why a control to suppress a speed of the host vehicle is being performed and that the speed of the host vehicle exceeds a control speed.

One aspect of the present disclosure is a vehicle control device including a processor configured to: suppress a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and perform a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

In the vehicle control device of the aspect (1), the processor may be configured to suppress the speed of the host vehicle to a second control speed which is a speed at which the host vehicle can stop safely within the distance from the current position of the host vehicle to a proceeding vehicle which is stopped when the blind curve is not included in the road and when the proceeding vehicle is included in the road.

In the vehicle control device of the aspect (1) or (2), the processor may be configured to perform the process to notify that the speed of the host vehicle exceeds the second control speed when the driver of the host vehicle performs the accelerator operation which makes the speed of the host vehicle higher than the second control speed during the execution of the control to suppress the speed of the host vehicle to the second control speed.

Another aspect of the present disclosure is a vehicle control method including: suppressing a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and performing a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

Another aspect of the present disclosure is a non-transitory recording medium having recorded thereon a computer program for causing a processor to perform a process including: suppressing a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and performing a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

According to the present disclosure, it is possible to make a driver of a host vehicle recognize a reason why a control to suppress a speed of the host vehicle is being performed and that the speed of the host vehicle exceeds a control speed.

### BRIEF DESCRIPTION OF DRAWINGS

FIG. 1 is a view showing an example of a host vehicle 1 to which a vehicle control device 14 of a first embodiment is applied.

FIG. 2 is a view for explaining an example in which a blind curve BC is included in a road RD on which the host vehicle 1 is traveling.

FIG. 3 is a view for explaining the example in which the blind curve BC is included in the road RD on which the host vehicle 1 is traveling.

FIG. 4 is a view for explaining an example in which the blind curve BC is not included in the road RD on which the host vehicle 1 is traveling, a proceeding vehicle PV which is stopped is included in the road RD on which the host vehicle 1 is traveling, and the proceeding vehicle PV which is stopped can be recognized from the host vehicle 1.

FIG. 5 is a view for explaining the example in which the blind curve BC is not included in the road RD on which the host vehicle 1 is traveling, the proceeding vehicle PV which is stopped is included in the road RD on which the host vehicle 1 is traveling, and the proceeding vehicle PV which is stopped can be recognized from the host vehicle 1.

FIG. 6 is a flowchart for explaining an example of a process performed by a processor 143 of the vehicle control device 14 of the first embodiment.

### DESCRIPTION OF EMBODIMENTS

Below, referring to the drawings, embodiments of a vehicle control device, a vehicle control method, and a non-transitory recording medium of the present disclosure will be explained.

### First Embodiment

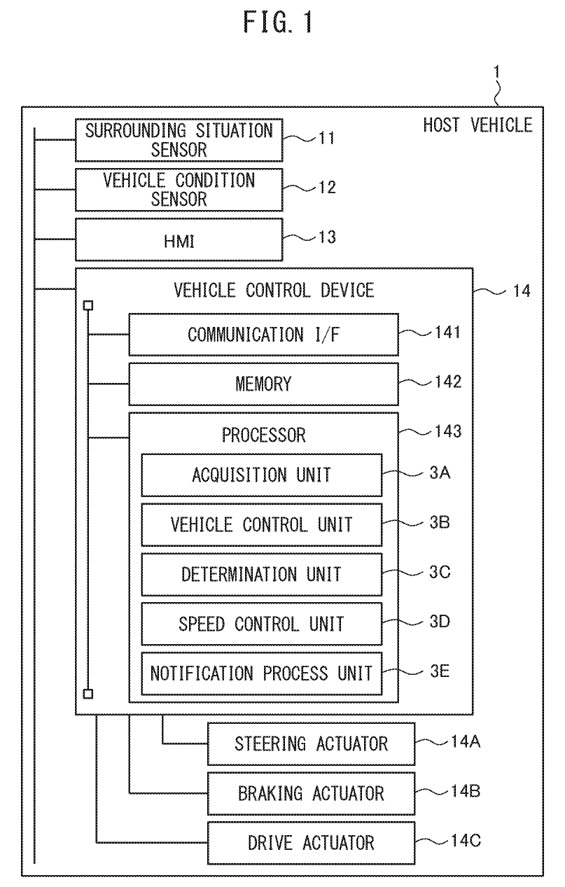

FIG. 1 is a view showing an example of a host vehicle 1 to which a vehicle control device 14 of a first embodiment is applied.

In the example shown in FIG. 1, the host vehicle 1 includes a surrounding situation sensor 11, a vehicle condition sensor 12, an HMI (Human Machine Interface) 13, the vehicle control device 14, a steering actuator 14A, a braking actuator 14B, and a drive actuator 14C.

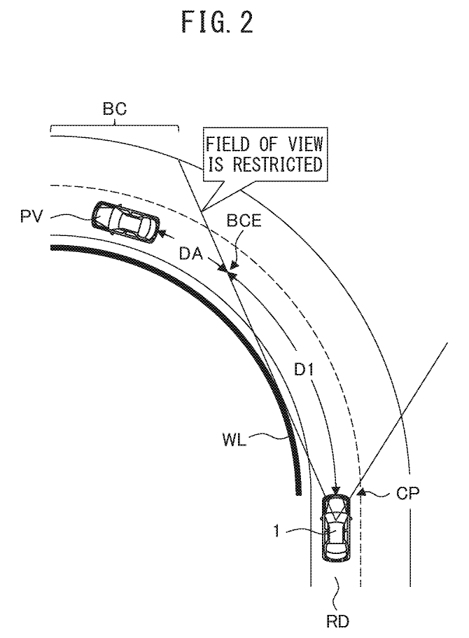

The surrounding situation sensor 11 detects a surrounding situation (such as a preceding vehicle PV (refer to FIG. 2) which is present on a road RD (refer to FIG. 2) on which the host vehicle 1 is traveling and which is traveling or is stopped, obstacles, pedestrians, and boundary line defining a lane in which the host vehicle 1 is traveling) of the host vehicle 1, and transmits the detection result to the vehicle control device 14. The surrounding situation sensor 11 includes, for example, radar, LiDAR (Light Detection And Ranging), camera, sonar, etc.

The vehicle condition sensor 12 detects the condition of the host vehicle 1 and sends the detection result to the vehicle control device 14. The vehicle condition sensor 12 includes, for example, a vehicle speed sensor, yaw rate sensor, etc.

The HMI 13 has the function of receiving various operations (such as operations to turn on Adaptive Cruise Control (ACC) and Lane Keep Assist as mentioned later, steering operation, braking operation, accelerator operation, etc.) by a driver of the host vehicle 1, and sends signals indicating the operations of the driver to the vehicle control device 14. Moreover, the HMI 13 has functions to provide various notifications to the driver of the host vehicle 1.

The vehicle control device 14 controls the steering actuator 14A, the braking actuator 14B, and the drive actuator 14C based on the information (data, signals) sent from the surrounding situation sensor 11, the vehicle condition sensor 12, and the HMI 13. The vehicle control device 14 is configured by a microcomputer equipped with a communication interface (I/F) 141, a memory 142, and a processor 143.

The communication interface 141 has an interface circuit for connecting the vehicle control device 14 to the surrounding situation sensor 11, the vehicle condition sensor 12, and the HMI 13. The memory 142 stores a program used in a process performed by the processor 143 and various data. The processor 143 has the function as an acquisition unit 3A, the function as a vehicle control unit 3B, the function as a determination unit 3C, the function as a speed control unit 3D, and the function as a notification process unit 3E.

The acquisition unit 3A acquires the detection result of the surrounding situation sensor 11 from the surrounding situation sensor 11, acquires the detection result of the vehicle condition sensor 12 from the vehicle condition sensor 12, and acquires the signals indicating various operations by the driver of host vehicle 1 which the HMI 13 has received from the HMI 13.

The vehicle control unit 3B has the function (e.g., driving assistance function such as the ACC, the Lane Keep Assist, etc.) to operate the steering actuator 14A, the braking actuator 14B, and the drive actuator 14C without requiring operations by the driver of host vehicle 1.

For example, when the ACC is ON and the preceding vehicle PV (refer to FIG. 2) exists on the road RD (refer to FIG. 2) on which the host vehicle 1 is traveling (specifically in the lane in which the host vehicle 1 is traveling), the vehicle control unit 3B operates the braking actuator 14B and the drive actuator 14C based on the detection result of the surrounding situation sensor 11 so that the host vehicle 1 follows the preceding vehicle PV and travels, without requiring operations by the driver of the host vehicle 1. Furthermore, when the ACC is ON and when the preceding vehicle PV is not present on the road RD on which the host vehicle 1 is traveling (the lane in which the host vehicle 1 is traveling), the vehicle control unit 3B operates the braking actuator 14B and drive actuator 14C so that host vehicle 1 travels at a speed set by the driver without requiring operations by the driver of the host vehicle 1.

For example, when the Lane Keep Assist is ON, the vehicle control unit 3B operates the steering actuator 14A so that the host vehicle 1 does not deviate from the lane in which the host vehicle 1 is traveling or the host vehicle 1 travels in the center of the lane in which the host vehicle 1 is traveling.

On the other hand, when the road RD (see FIG. 2) on which the host vehicle 1 is traveling includes a blind curve BC (see FIG. 2), there is a possibility that the preceding vehicle PV (see FIG. 2) which is present on the road RD on which the host vehicle 1 is traveling (specifically in the lane in which the host vehicle 1 is traveling) and which is stopped cannot be recognized from the host vehicle 1 based on the detection result of the surrounding situation sensor 11.

Therefore, in the vehicle control device 14 of the first embodiment, countermeasures described later are implemented so that the host vehicle 1 can travel safely even when the blind curve BC is included in the road RD on which the host vehicle 1 is traveling.

Specifically, in the example shown in FIG. 1, the determination unit 3C determines whether the blind curve BC (see FIG. 2) where the presence of the preceding vehicle PV (see FIG. 2) which is stopped cannot be recognized based on the detection result of the radar as the surrounding situation sensor 11, is included in the road RD (see FIG. 2) on which the host vehicle 1 is traveling. For example, when the detection result of the surrounding situation sensor 11 indicating that the road RD (lane in which the host vehicle 1 is traveling) on which the host vehicle 1 is traveling does not exist at a predetermined distance from the host vehicle 1 is acquired by the acquisition unit 3A, the determination unit 3C determines that the blind curve BC is included in the road RD on which the host vehicle 1 is traveling.

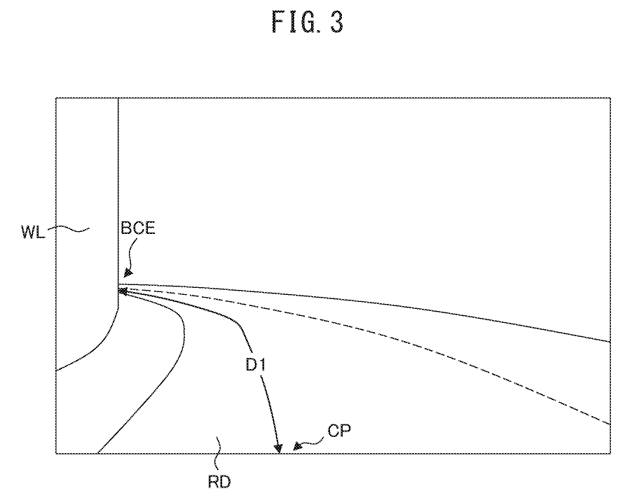

When the determination unit 3C determines that the blind curve BC is included in the road RD on which the host vehicle 1 is traveling, the speed control unit 3D executes a control to suppress the speed of the host vehicle 1 to a first control speed which is a speed at which the host vehicle 1 can stop safely within the distance D1 (see FIGS. 2 and 3) from a current position CP (see FIGS. 2 and 3) of the host vehicle 1 to the blind curve BC (specifically, the entrance BCE (see FIGS. 2 and 3) of the blind curve BC). Specifically, if the speed (set speed) set by the driver of the host vehicle 1 when the ACC is turned ON is higher than the first control speed, the speed control unit 3D executes the control to decelerate the host vehicle 1 from the set speed to the first control speed.

FIGS. 2 and 3 are views for explaining an example in which the blind curve BC is included in a road RD on which the host vehicle 1 is traveling. Specifically, FIG. 2 shows the relationship between the host vehicle 1 and the preceding vehicle PV when the road RD on which the host vehicle 1 is traveling includes the blind curve BC and when the preceding vehicle PV which is stopped exists in the blind curve BC. FIG. 3 shows an image of the front of the host vehicle 1 captured by a camera as the surrounding situation sensor 11 in the situation shown in FIG. 2.

In the example shown in FIGS. 2 and 3, the road RD on which the host vehicle 1 is traveling curves to the left, and a side wall WL exists on the left side of the road RD on which the host vehicle 1 is traveling.

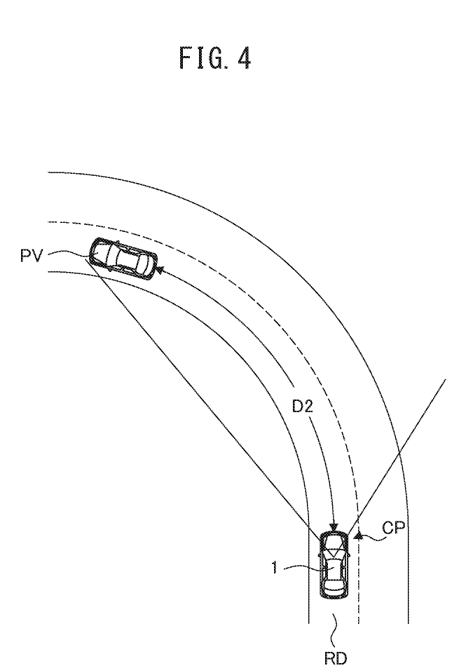

Therefore, the determination unit 3C determines that the blind curve BC where the presence of the preceding vehicle PV which is stopped cannot be recognized based on detection result of the radar as the surrounding situation sensor 11, is included in the road RD on which the host vehicle 1 is traveling. Furthermore, the speed control unit 3D executes the control to suppress the speed of the host vehicle 1 to the speed (first control speed) at which the host vehicle 1 can stop safely within the distance D1 from the current position CP of the host vehicle 1 to the entrance BCE of the blind curve BC. As shown in FIG. 2, the distance D1 from the current position CP of the host vehicle 1 to the entrance BCE of the blind curve BC is the value obtained by subtracting the distance DA from the entrance BCE of the blind curve BC to the preceding vehicle PV from the distance D2 (see FIG. 4) from the current position CP of the host vehicle 1 to the preceding vehicle PV.

As a result, in the example shown in FIGS. 2 and 3, the host vehicle 1 can be traveled safely so as not to collide with the preceding vehicle PV which is stopped and is present in the blind curve BC.

On the other hand, when the driver of the host vehicle 1 does not recognize the reason why the control to suppress the speed of the host vehicle 1 to the first control speed is being executed by the speed control unit 3D, there is a risk that the driver of the host vehicle 1 might perform an accelerator operation which makes the speed of the host vehicle 1 higher than the first control speed during the execution of the control to suppress the speed of the host vehicle 1 to the first control speed.

Therefore, in the example shown in FIG. 1, when the driver of the host vehicle 1 performs the accelerator operation which makes the speed of the host vehicle 1 higher than the first control speed during the execution of the control by the speed control unit 3D, the notification process unit 3E performs a process to notify that the speed of the host vehicle 1 exceeds the first control speed (specifically, process to cause the HMI 13 to notify that the speed of the host vehicle 1 exceeds the first control speed). Moreover, the notification process unit 3E also executes a process to notify the reason why the speed of the host vehicle 1 is being suppressed to the first control speed.

Therefore, in the example shown in FIG. 1, it is possible to make the driver of the host vehicle 1 to recognize the reason why the control to suppress the speed of the host vehicle 1 to the first control speed and that the speed of the host vehicle 1 exceeds the first control speed.

In other example, the process to notify the reason why the speed of the host vehicle 1 is suppressed to the first control speed may not be performed by the notification process unit 3E.

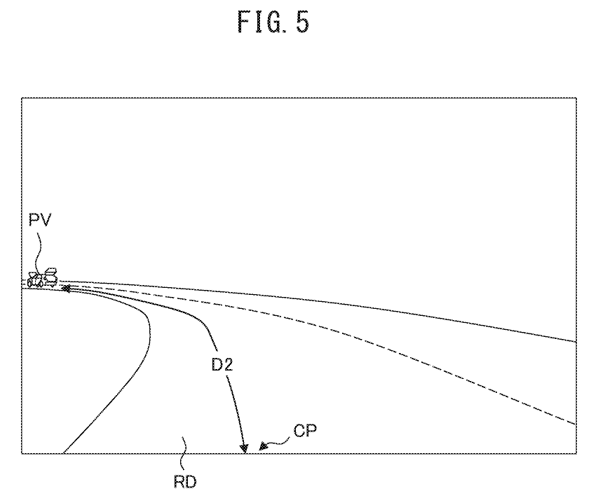

FIGS. 4 and 5 are views for explaining an example in which the blind curve BC is not included in the road RD on which the host vehicle 1 is traveling, the proceeding vehicle PV which is stopped is included (present) in the road RD on which the host vehicle 1 is traveling, and the proceeding vehicle PV which is stopped can be recognized from the host vehicle 1. Specifically, FIG. 4 shows the relationship between the host vehicle 1 and the preceding vehicle PV when the road RD on which the host vehicle 1 is traveling does not include the blind curve BC and when the preceding vehicle PV which is stopped is included in the road RD on which the host vehicle 1 is traveling. FIG. 5 shows the image of the front of the host vehicle 1 captured by the camera as the surrounding situation sensor 11 in the situation shown in FIG. 4.

In the example shown in FIGS. 4 and 5, the road RD on which the host vehicle 1 is traveling curves to the left, and there is no obstacle such as a side wall WL (see FIGS. 2 and 3) which obstructs the view from the host vehicle 1, on the left side of the road RD on which the host vehicle 1 is traveling.

Therefore, the determination unit 3C determines that the blind curve BC is not included in the road RD on which the host vehicle 1 is traveling, based on the detection result of the radar as the surrounding situation sensor 11. Furthermore, the determination unit 3C determines that the preceding vehicle PV which is stopped is included (exists) on the road RD on which the host vehicle 1 is traveling, based on the detection result of the radar as the surrounding situation sensor 11. The speed control unit 3D executes the control to suppress the speed of the host vehicle 1 to a speed (second control speed) (> first control speed) at which the host vehicle 1 can stop safely within the distance D2 (>D1) from the current position CP of the host vehicle 1 to the preceding vehicle PV.

As a result, in the example shown in FIGS. 4 and 5, the host vehicle 1 can be traveled safely so as not to collide with the preceding vehicle PV which is stopped and is present on the road RD on which the host vehicle 1 is traveling.

On the other hand, when the driver of the host vehicle 1 does not recognize the reason why the control to suppress the speed of the host vehicle 1 to the second control speed is being executed by the speed control unit 3D, there is a risk that the driver might perform the accelerator operation which makes the speed of the host vehicle 1 higher than the second control speed during the execution of the control to suppress the speed of the host vehicle 1 to the second control speed.

Therefore, in the example shown in FIGS. 4 and 5, when the driver of the host vehicle 1 performs the accelerator operation which makes the speed of the host vehicle 1 higher than the second control speed during the execution of the control by the speed control unit 3D, the notification process unit 3E performs the process to notify that the speed of the host vehicle 1 exceeds the second control speed (specifically, process to cause the HMI 13 to notify that the speed of the host vehicle 1 exceeds the second control speed). Moreover, the notification process unit 3E also executes the process to notify the reason why the speed of the host vehicle 1 is being suppressed to the second control speed.

Therefore, in the example shown in FIGS. 4 and 5, it is possible to make the driver of the host vehicle 1 to recognize the reason why the control to suppress the speed of the host vehicle 1 to the second control speed and that the speed of the host vehicle 1 exceeds the second control speed.

In other example, the process to notify the reason why the speed of the host vehicle 1 is suppressed to the second control speed may not be performed by the notification process unit 3E.

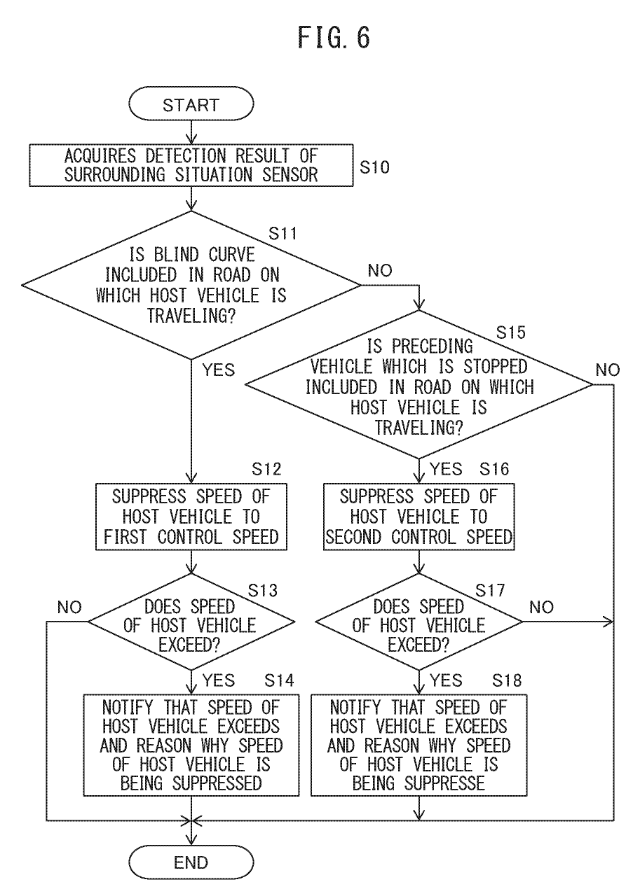

FIG. 6 is a flowchart for explaining an example of the process performed by the processor 143 of the vehicle control device 14 of the first embodiment.

The process shown in FIG. 6 is performed, for example, when driving assistance such as ACC is executed by the vehicle control unit 3B.

In the example shown in FIG. 6, at step S10, the acquisition unit 3A acquires the detection result of the radar which serves as the surrounding situation sensor 11 from the surrounding situation sensor 11.

At step S11, the determination unit 3C determines whether the blind curve BC where the presence of the preceding vehicle PV which is stopped cannot be recognized based on the detection result of the radar serving as the surrounding situation sensor 11 acquired at step S10, is included in the road RD on which the host vehicle 1 is traveling. When YES, it proceeds to step S12, and when NO, it proceeds to step S15.

At step S12, the speed control unit 3D executes the control to suppress the speed of the host vehicle 1 to the first control speed which is the speed at which the host vehicle 1 can stop safely within the distance D1 from the current position CP of the host vehicle 1 to the entrance BCE of the blind curve BC.

At step S13, the determination unit 3C determines whether the speed of the host vehicle 1 exceeds the first control speed (whether the driver of the host vehicle 1 performed the accelerator operation which makes the speed of the host vehicle 1 higher than the first control speed). When YES, it proceeds to step S14, and when NO, it ends the process shown in FIG. 6.

At step S14, the notification process unit 3E performs the process to notify that the speed of the host vehicle 1 exceeds the first control speed and the reason why the speed of the host vehicle 1 is being suppressed to the first control speed.

At step S15, the determination unit 3C determines whether the preceding vehicle PV which is stopped is included (exists) on the road RD on which the host vehicle 1 is traveling based on the detection result of the radar as the surrounding situation sensor 11 acquired at step S10. When YES, it proceeds to step S16; when NO, it ends the process shown in FIG. 6.

At step S16, the speed control unit 3D executes the control to suppress the speed of the host vehicle 1 to the second control speed at which the host vehicle 1 can stop safely within the distance D2 from the current position CP to the preceding vehicle PV which is stopped.

At step S17, the determination unit 3C determines whether the speed of the host vehicle 1 exceeds the second control speed (whether the driver of host vehicle 1 performed the accelerator operation which makes the speed of host vehicle 1 higher than the second control speed). When YES, it proceeds to step S18; when NO, it ends the process shown in FIG. 6.

At step S18, the notification process unit 3E performs the process to notify that the speed of the host vehicle 1 exceeds the second control speed and the reason why the speed of the host vehicle 1 is being suppressed to the second control speed.

In an open curve as shown in FIGS. 4 and 5, at which the preceding vehicle PV which is stopped on the road RD on which the host vehicle 1 is traveling can be recognized from the host vehicle 1, and in the blind curve BC as shown in FIGS. 2 and 3 at which the preceding vehicle PV which is stopped on the road RD on which the host vehicle 1 is traveling cannot be recognized from the host vehicle 1, the speed at which the host vehicle 1 can safely travel with ACC or the like differs.

Therefore, in the host vehicle 1 to which the vehicle control device 14 of the first embodiment is applied, as mentioned above, in the open curve at which the preceding vehicle PV which is stopped on the road RD on which the host vehicle 1 is traveling can be recognized from the host vehicle 1, the speed control unit 3D executes the control to suppress the speed of the host vehicle 1 to the second control speed (>first control speed) at which the host vehicle 1 can stop safely within the distance D2 (>D1) from the current position CP to preceding vehicle PV. In the blind curve BC at which the preceding vehicle PV which is stopped on the road RD on which the host vehicle 1 is traveling cannot be recognized from the host vehicle 1, the speed control unit 3D executes the control to suppress the speed of host vehicle 1 to the first control speed at which the host vehicle 1 can safely stop within the distance D1 from the current position CP to the entrance BCE of the blind curve BC.

### Second Embodiment

The host vehicle 1 to which the vehicle control device 14 of a second embodiment is applied is configured similarly to the host vehicle 1 to which the vehicle control device 14 of the first embodiment is applied, except for points to be described later.

As mentioned above, in the example shown in FIG. 1 (example of the host vehicle 1 to which the vehicle control device 14 of the first embodiment is applied), the determination unit 3C determines whether the blind curve BC where the presence or absence of the preceding vehicle PV which is stopped cannot be recognized based on the detection result of the radar as the surrounding situation sensor 11 is included in the road RD on which the host vehicle 1 is traveling.

On the other hand, in an example of the host vehicle 1 to which the vehicle control device 14 of the second embodiment is applied, the determination unit 3C determines whether the blind curve BC where the presence or absence of the preceding vehicle PV which is stopped cannot be recognized based on the detection result (LiDAR point cloud) of the LiDAR as the surrounding situation sensor 11 is included in the road RD on which the host vehicle 1 is traveling.

Also, as mentioned above in the example shown in FIG. 1, the determination unit 3C determines whether the preceding vehicle PV which is stopped is included (present) in the road RD on which host vehicle 1 is traveling based on the detection result of the radar as the surrounding situation sensor 11.

On the other hand, in the example of host vehicle 1 to which the vehicle control device 14 of the second embodiment is applied, the determination unit 3C determines whether the preceding vehicle PV which is stopped is included (present) in the road RD on which host vehicle 1 is traveling based on the detection result (LiDAR point cloud) of the LiDAR as the surrounding situation sensor 11.

### Third Embodiment

The host vehicle 1 to which the vehicle control device 14 of a third embodiment is applied is configured similarly to the host vehicle 1 to which the vehicle control device 14 of the first embodiment is applied, except for points to be described later.

In the example of host vehicle 1 to which the vehicle control device 14 of the third embodiment is applied, the determination unit 3C determines whether the blind curve BC where the presence or absence of the preceding vehicle PV which is stopped cannot be recognized based on the detection result (e.g., camera image as shown in FIG. 3) of the camera as the surrounding situation sensor 11 is included in the road RD on which the host vehicle 1 is traveling.

Also, the determination unit 3C determines whether the preceding vehicle PV which is stopped is included (present) in the road RD on which host vehicle 1 is traveling based on the detection result (e.g., camera image as shown in FIG. 5) of the camera as the surrounding situation sensor 11.

As described above, although the embodiments of the vehicle control device, the vehicle control method, and the non-transitory recording medium of the present disclosure have been described with reference to the drawings, the vehicle control device, the vehicle control method, and the non-transitory recording medium of the present disclosure are not limited to the embodiments described above, and may be appropriately changed without departing from the scope of the present disclosure. The configuration of each example of the embodiment described above may be appropriately combined. In each example of the above-described embodiment, the process performed in the vehicle control device 14 has been described as software process performed by executing the program, but the process performed in the vehicle control device 14 may be process performed by hardware. Alternatively, the process performed by the vehicle control device 14 may be a combination of both software and hardware. Further, the program (program for realizing the function of the processor 143 of the vehicle control device 14) stored in the memory 142 of the vehicle control device 14 may be recorded in a computer-readable storage medium (non-transitory recording medium) such as, semiconductor memory, magnetic recording medium, optical recording medium, or the like for providing, distribution or the like.

What is claimed is:

1. A vehicle control device comprising a processor configured to:
suppress a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and
perform a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

2. The vehicle control device according to claim 1, wherein the processor is configured to suppress the speed of the host vehicle to a second control speed which is a speed at which the host vehicle can stop safely within the distance from the current position of the host vehicle to a proceeding vehicle which is stopped when the blind curve is not included in the road and when the proceeding vehicle is included in the road.

3. The vehicle control device according to claim 2, wherein the processor is configured to perform the process to notify that the speed of the host vehicle exceeds the second control speed when the driver of the host vehicle performs the accelerator operation which makes the speed of the host vehicle higher than the second control speed during the execution of the control to suppress the speed of the host vehicle to the second control speed.

4. A vehicle control method comprising:
suppressing a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and
performing a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.

5. A non-transitory recording medium having recorded thereon a computer program for causing a processor to perform a process comprising:
suppressing a speed of a host vehicle to a first control speed which is a speed at which the host vehicle can stop safely within the distance from a current position of the host vehicle to a blind curve which cannot be recognized based on a detection result of a surrounding situation sensor which detect a surrounding situation of the host vehicle when the blind curve is included in a road on which the host vehicle is traveling; and
performing a process to notify that the speed of the host vehicle exceeds the first control speed when a driver of the host vehicle performs an accelerator operation which makes the speed of the host vehicle higher than the first control speed during the execution of a control to suppress the speed of the host vehicle to the first control speed.
